(19) United States
(12) Patent Application Publication
(10) Pub. No.: US 2014/0139025 A1
(43) Pub. Date: May 22, 2014

(54) POWER CONTROL DEVICE AND POWER CONTROL METHOD

(71) Applicants: INVENTEC (PUDONG) TECHNOLOGY CORPORATION, Shanghai (CN); INVENTEC CORPORATION, Taipei (TW)

(72) Inventor: Ming-Ying Lee, Taipei (TW)

(73) Assignees: INVENTEC CORPORATION, Taipei (TW); Inventec (Pudong) Technology Corporation, Shanghai (CN)

(21) Appl. No.: 13/789,025

(22) Filed: Mar. 7, 2013

(30) Foreign Application Priority Data
Nov. 16, 2012 (CN) 201210464383.9

(51) Int. Cl. H02J 1/00

(52) U.S. Cl. CPC H02J 1/00
USPC 307/39

(57) ABSTRACT

A power control device and a power control method are presented, wherein the power control device is selectively and electrically coupled to a plurality of power distribution units (PDUs), and receives a DC voltage. The power control device includes a first connection port, a plurality of second connection ports, a plurality of control units, and a plurality of switch units. The first connection port receives and outputs the DC voltage. The second connection ports are coupled to the corresponding PDUs respectively, and each of the second connection ports outputs a loop signal when coupling to the corresponding PDU. Each control unit generates and outputs a control signal to the corresponding switch unit when receiving the loop signal, so that the switch unit determines whether to be turned on, according to the corresponding control signal.

### CROSS-REFERENCE TO RELATED APPLICATIONS

This non-provisional application claims priority under 35 U.S.C. §119(a) on Patent Application No(s). 201210464383.9 filed in China on Nov. 16, 2012, the entire contents of which are hereby incorporated by reference.

### BACKGROUND

1. Technical Field

The disclosure relates to a power control device, and more particularly to a power control device and a power control method capable of avoiding an electric arc and an excessive inrush current.

2. Related Art

A container server is generally configured with a plurality of power distribution units (PDUs). The PDUs are connected in parallel and supplied by a high voltage direct current (DC) power, for example, a DC voltage of 342V to 418V, so as to supply a working voltage to each mainboard in the container server after a DC-to-DC buck conversion.

Since the PDU is directly supplied by the high voltage DC power, when a user hot-plugs the mainboard into the container server to make an electrical coupling between the PDU and the mainboard, an electric arc may occurs. This causes damages or burning of a connection port used for connecting the mainboard to the PDU.

In addition, if the user hot-plugs a large number of the mainboards into the container server to make an electrical coupling between the PDUs and the mainboards at the same time, since the PDUs are connected in parallel, an excessive inrush current is generated. This may cause damages to circuit components.

### SUMMARY

The disclosure relates to a power control device which is selectively and electrically coupled to a plurality of PDUs for receiving a DC voltage. The power control device comprises a first connection port, a plurality of switch units, a plurality of second connection ports, and a plurality of control units. The first connection port receives and outputs the DC voltage. The second connection ports are coupled to the PDUs respectively, and each of the second connection ports outputs a loop signal when being coupled to the corresponding PDU. The control units are coupled to the second connection ports respectively, and each of the control units generates and outputs a control signal when receiving the loop signal. The switch units are coupled to the first connection port, and each of the switch unit is coupled to the corresponding second connection port. The switch units receive the DC voltage, and each of the switch units determines whether to output the DC voltage to the corresponding second connection port according to the control signal output by the corresponding control unit.

In an embodiment, each control unit has a delay period, and the delay periods are different, so as to generate and output the control signal after the delay period when receiving the loop signal.

In an embodiment, the delay periods of the control units are in decreasing order or in increasing order.

In an embodiment, the switch unit comprises a coil and at least one connection portion. The coil receives the control signal, and the connection portion electrically connects the first connection port to the corresponding second connection port when the coil receives the control signal.

The disclosure relates to a power control method which is adapted to a power control device. The power control device is selectively and electrically coupled to N PDUs, receives a DC voltage, and comprises M switch units. The power control method comprises following steps. When the power control device is electrically coupled to one of the PDUs, a loop signal is generated. A control signal is generated according to the loop signal. It is performed according to the control signal to determine whether to turn on one of the switch units. N and M are both positive integers greater than or equal to zero, and N is a multiple of M.

In an embodiment, when the power control device is electrically coupled to two adjacent ones of the N PDUs, the two adjacent PDUs generate the corresponding control signals having a delay period therebetween.

### BRIEF DESCRIPTION OF THE DRAWINGS

The disclosure will become more fully understood from the detailed description given herein below for illustration only, and thus is not limitative of the disclosure, and wherein:

FIG. 1 is a schematic diagram of a power control device in the disclosure; and

FIG. 2 is a flow chart of a power control method in the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

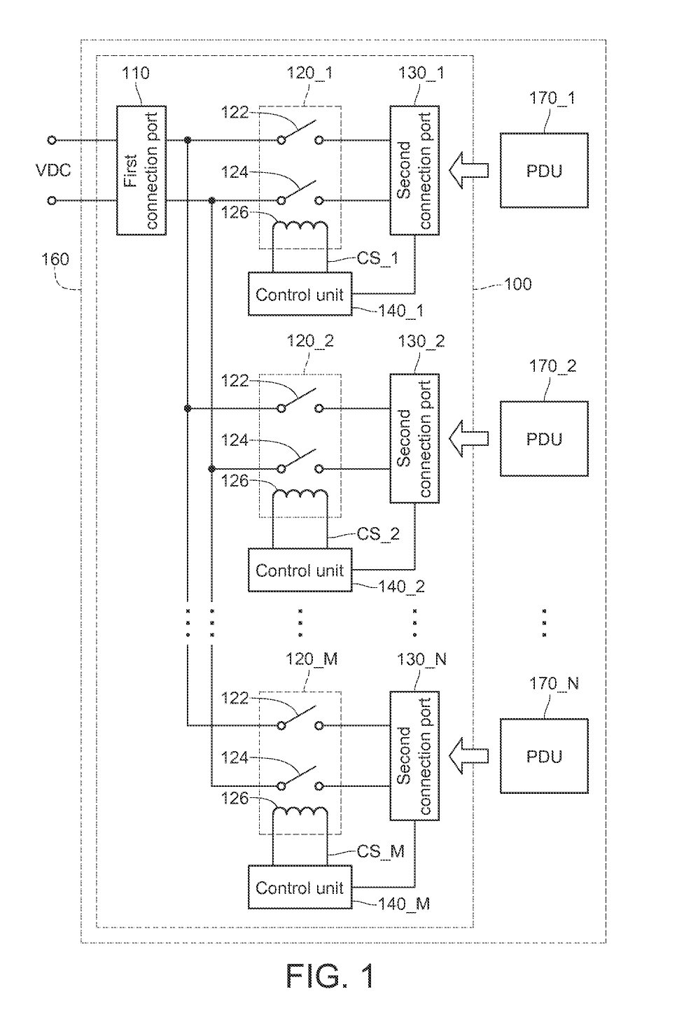

FIG. 1 is a schematic diagram of a power control device in the disclosure. The power control device 100 in this embodiment is adapted to a rack 160 including a plurality of servers, switches and rack management controllers (not shown). The servers, switches, and rack management controllers need to be powered to operate. The simplest design is to configure a PDU respectively for each server, switch, and rack management controller. Therefore, in this embodiment, the rack 160 includes a plurality of PDUs 170_1 to 170_N, so as to supply working voltages required by the rack 160 and enable the rack 160 to work normally. In this embodiment, the power control device 100 comprises a first connection port 110, a plurality of switch units 120_1 to 120_M, a plurality of second connection ports 130_1 to 130_N, and a plurality of control units 140_1 to 140_M, where N and M are both positive integers greater than 1.

In the embodiment of the disclosure, it is taken as an example that N is equal to M. In an actual design, N can be a multiple of M, that is, two or more second connection ports share one switch unit and one control unit, and the actual amounts of these elements are determined according to the requirements of the design.

The second connection ports 130_1 to 130_N are coupled to the PDUs 170_1 to 170_N of the rack 160 respectively. In this embodiment, the second connection ports 130_1 to 130_N are coupled to the PDUs 170_1 to 170_N one-to-one. For example, the second connection port 130_1 is corresponding to the PDU 170_1, and the second connection port 130_2 is corresponding to the PDU 170_2. In this way, it can be learn that the second connection port 130_N is corresponding to the PDU 170_N.

When one of the second connection ports 130_1 to 130_N is coupled to one of the PDUs 170_1 to 170_N to form a loop, the coupled second connection port outputs a loop signal to corresponding one of the control units 140_1 to 140_M.

The second connection ports 130_1 to 130_N are coupled to the switch units 120_1 to 120_M respectively. Specifically, the second connection ports 130_1 to 130_N are coupled to the switch units 120_1 to 120_M one-to-one. For example, the second connection port 130_1 is coupled to the switch unit 130_1, and the second connection port 130_2 is coupled to the switch unit 120_2. In this way, it can be learn that the second connection port 130_N is coupled to the switch unit 120_M. In this embodiment, the second connection ports 130_1 to 130_N are, for example, connection ports having a hot-plug function.

The switch units 120_1 to 120_M are coupled to the first connection port 110 and the second connection ports 130_1 to 130_N, and the switch units 120_1 to 120_M receive a DC voltage VDC through the first connection port 110. The DC voltage VDC is, for example, supplied by a DC PDU, and the voltage value of the DC voltage VDC is, for example, between 342V and 450V. Each of the switch units 120_1 to 120_M comprises connection portions 122 and 124 and a coil 126. Two ends of each of the connection portions 122 and 124 are coupled to the first connection port 110 and corresponding one of the second connection ports 130_1 to 130_N respectively.

The control units 140_1 to 140_M are coupled to the switch units 120_1 to 120_M and the second connection ports 130_1 to 130_N respectively, so as to correspondingly generate control signals CS_1 to CS_M according to the loop signals outputted by the second connection ports 130_1 to 130_N.

Specifically, the control units 140_1 to 140_M correspond to the second connection ports 130_1 to 130_N one-to-one. For example, the control unit 140_1 corresponds to the second connection port 130_1, and the control unit 140_2 corresponds to the second connection port 130_2. In this way, it can be learn that the control unit 140_M corresponds to the second connection port 130_N. In this and some embodiments, the control units 140_1 to 140_M correspondingly generate the control signals CS_1 to CS_M according to the loop signals representing the connection states of the second connection ports 130_1 to 130_N and the PDUs 170_1 to 170_N.

The switch units 120_1 to 120_M determine whether to be turned on, according to the control signals CS_1 to CS_M respectively. That is to say, the switch units 120_1 to 120_M correspond to the control signals CS_1 to CS_M one-to-one. For example, the switch unit 120_1 corresponds to the control signal CS_1, and the switch unit 120_2 corresponds to the control signal CS_2. In this way, it can be learn that the switch unit 120_M corresponds to the control signal CS_N.

The switch units 120_1 to 120_M determine whether to be turned on or not, according to the logic level of the control signals CS_1 to CS_M. For example, when the control signals CS_1 to CS_M are at a high logic level (that is “1”), the coils 126 in the switch units 120_1 to 120_M generate an electromagnetic effect, so that the connection portions 122 and 124 are switched on. Herein, the DC voltage VDC is outputted and supplied to the second connection ports 130_1 to 130_N through the switch units 120_1 to 120_M. When the control signals CS_1 to CS_M are at a low logic level (that is “0”), the connection portions 122 and 124 in the switch units 120_1 to 120_M are switched off, and the DC voltage VDC is not allowed to supply to the second connection ports 130_1 to 130_N through the switch units 120_1 to 120_M. In this and some embodiments, the switch units 120_1 to 120_M are relays withstanding the high DC voltage, for example, withstanding a high DC voltage of 450V.

The control units 140_1 to 140_M are coupled to the switch units 120_1 to 120_M and the second connection ports 130_1 to 130_N respectively, so as to correspondingly generate the control signals CS_1 to CS_M according to the loop signals outputted by the second connection ports 130_1 to 130_N.

Specifically, the control units 140_1 to 140_M correspond to the second connection ports 130_1 to 130_N one-to-one. For example, the control unit 140_1 corresponds to the second connection port 130_1, and the control unit 140_2 corresponds to the second connection port 130_2. In this way, it can be learn that the control unit 140_M corresponds to the second connection port 130_N.

In this and some embodiments, the control units 140_1 to 140_M detect the connection states of the second connection ports 130_1 to 130_N and the PDUs 170_1 to 170_N, so as to correspondingly generate the control signals CS_1 to CS_M.

In this and some embodiments, when the second connection port 130_1 is coupled to the PDU 170_1, the second connection port 130_1 is under a coupled state. Herein, the control unit 140_1 correspondingly generates, for example, the control signal CS_1 at the high logic level according to the loop signal. When the second connection port 130_1 is not coupled to the PDU 170_1, the second connection port 130_1 is under an uncoupled state. Herein, the control unit 140_1 correspondingly generates, for example, the control signal CS_1 at a low logic level according to the loop signal, or the second connection port 130_1 does not output the loop signal. Operations of the other control units 140_2 to 140_M can be deduced by analogy, which is not described herein again.

Therefore, the control units 140_1 to 140_M control whether to turn on or off the switch units 120_1 to 120_M, according to the connection states of the second connection ports 130_1 to 130_N, so as to effectively isolate the DC voltage VDC from the second connection ports 130_1 to 130_N. In addition, when the PDUs 170_1 to 170_N are coupled to the second connection ports 130_1 to 130_N, and after the switch units 120_1 to 120_M are turned on, the DC voltage VDC is supplied to the PDUs 170_1 to 170_N, thereby avoiding an electric arc caused by the DC voltage VDC directly supplied to the PDUs 170_1 to 170_N.

In this and some embodiments, the control units 140_1 to 140_M are set with different delay periods, so that the control signals CS_1 to CS_M are generated according to the delay periods respectively.

For example, it is assumed that the control unit 140_1 is set with a delay period of 1 millisecond (ms), and when detecting that the second connection port 130_1 is coupled to the PDU 170_1, the control unit 140_1 generates, for example, the control signal CS_1 at the high logic level after 1 ms. It is assumed that the control unit 140_2 is set with a delay period of 5 ms, and when detecting that the second connection port 130_2 is coupled to the PDU 170_2, the control unit 140_2 generates, for example, the control signal CS_2 at the high logic level after 5 ms. It is assumed that the control unit 140_3 is set with delay period of 3 ms, and when detecting that the second connection port 130_3 is coupled to the PDU 170_3, the control unit 140_3 generates, for example, the control signal CS_3 at the high logic level after 3 ms. Setting manners of the delay periods of the other control units 140_4 to 140_M and operations thereof can be deduced by analogy.

Specifically, the delay periods are in increasing order. For example, the delay period of the control unit 140_1 is 1 ms, the delay period of the control unit 140_2 is 2 ms, the delay period of the control unit 140_3 is 3 ms, and the rest can be deduced by analogy. In another embodiment, the delay period of the control unit 140_1 is, for example, 10 ms, the delay period of the control unit 140_2 is, for example, 9 ms, the delay period of the control unit 140_3 is, for example, 8 ms, and the rest can be deduced by analogy. The disclosure is not limited thereto, and the delay periods of the control units 140_1 to 140_M can be set according to various requirements, and the relative manner can refer to the foregoing description, which is not described herein again.

In this and some embodiments, the control units 140_1 to 140_M are set with different delay periods, so that when the PDUs 170_1 to 170_N are coupled to the second connection ports 130_1 to 130_N simultaneously, the control units 140_1 to 140_M output, for example, the control signals CS_1 to CS_M at the high logic level to the switch units 120_1 to 120_M at different time points. Thus, the DC voltage VDC is supplied to the PDUs 170_1 to 170_N respectively. When the multiple PDUs 170_1 to 170_N are not coupled to the DC voltage VDC simultaneously, an excessive inrush current causing malfunction of the server may not occur.

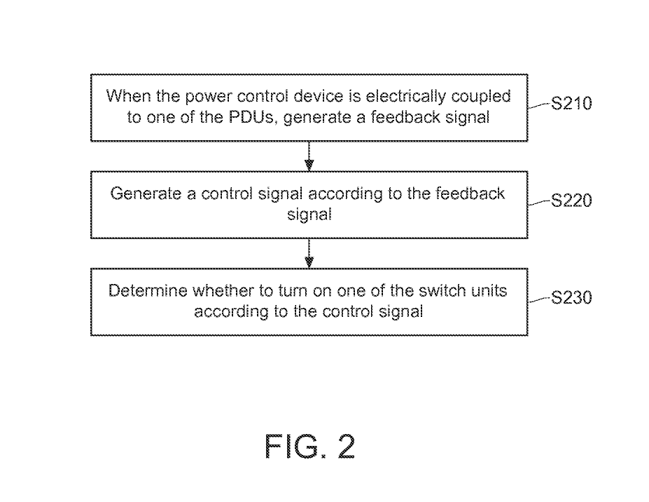

According to the foregoing description, a power control method is concluded. FIG. 2 is a flow chart of the power control method in the disclosure. The power control method of this embodiment is adapted to a power control device. The power control device is selectively and electrically coupled to N PDUs, receives a DC voltage, and comprises M switch units.

In Step S210, when the power control device is electrically coupled to one of the PDUs, a loop signal is generated. In Step S220, a control signal is generated according to the loop signal. In Step S230, it is performed according to the control signal to determine whether one of the switch units is turned on. N and M are both positive integers greater than or equal to zero, and N is a multiple of M. In this embodiment, when the power control device is electrically coupled to two adjacent ones of the N PDUs, the two adjacent PDUs generate the corresponding control signals having a delay period therebetween.

For the power control device and the power control method in the disclosure, the control unit detects the connection state of the second connection port and the PDU to control the switch unit to be turned on accordingly, so as to supply the DC voltage received by the first connection port, to the PDU through the second connection port. Thus, an electric arc may not occur when the PDU is not directly supplied by the high voltage DC voltage. In addition, each control unit is set with its delay period, so that the control signals are generated at different time points, thereby effectively avoiding an excessive inrush current caused by the fact that a plurality of PDUs are supplied by the high voltage DC voltage simultaneously.

What is claimed is:

1. A power control device, selectively and electrically coupled to a plurality of power distribution units, receiving a direct current voltage, and comprising:
a first connection port, for receiving and outputting the direct current voltage;
a plurality of second connection ports, coupled to the power distribution units respectively, and each second connection port outputting a loop signal when being coupled to corresponding one of the power distribution units;
a plurality of control units, coupled to the second connection ports respectively, and each control unit generating and outputting a control signal when receiving the loop signal; and
a plurality of switch units, coupled to the first connection port, and respectively coupled to the second connection ports, for receiving the direct current voltage, and each switch unit determining whether to output the direct current voltage to the corresponding second connection port according to the control signal outputted by the corresponding control unit.

2. The power control device according to claim 1, wherein each of the control units has a delay period, and the delay periods are different, so as to generate and output the control signal after the delay period when receiving the loop signal.

3. The power control device according to claim 2, wherein the delay periods of the control units are in decreasing order or in increasing order.

4. The power control device according to claim 1, wherein each of the switch units comprises:
a coil, electrically coupled to the control unit, for receiving the control signal; and
at least one connection portion, electrically coupled to the first connection port and the corresponding second connection port respectively, for electrically connecting the first connection port to the corresponding second connection port when the coil receives the control signal.

5. A power control method, adapted to a power control device which is selectively and electrically coupled to N power distribution units to receive a direct current voltage and comprises M switch units, the power control method comprising:
when the power control device is electrically coupled to one of the N power distribution units, generating a loop signal;
generating a control signal according to the loop signal; and
determining whether to turn on one of the M switch units according to the control signal,
N and M both being positive integers greater than or equal to zero, and N being a multiple of M.

6. The power control method according to claim 5, wherein when the power control device is electrically coupled to two adjacent ones of the N power distribution units, the two adjacent power distribution units generate the corresponding control signals having a delay period therebetween.
